(19) United States
(12) Patent Application Publication
(10) Pub. No.: US 2011/0264880 A1
(43) Pub. Date: Oct. 27, 2011

(54) Object copying with re-copying concurrently written objects

(75) Inventor: Tatu J. Ylonen, Espoo (FI)

(73) Assignee: TATU YLONEN OY LTD, Espoo (FI)

(21) Appl. No.: 12/772,496

(22) Filed: May 3, 2010

Related U.S. Application Data
(60) Provisional application No. 61/327,374, filed on Apr. 23, 2010.

(51) Int. Cl. G06F 12/00; G06F 12/02; G06F 12/16

(52) U.S. Cl. 711/162; 711/170; 711/E12.001; 711/E12.009; 711/E12.103

(57) ABSTRACT

Objects are copied concurrently with mutator execution, while tracking writes to the objects being copied. Objects (or fields) that are written into during copying are re-copied to the same destination locations. Mutators use the original objects until copying is complete and are, in some embodiments, atomically (with respect to the mutators) switched to use the new copies, together with a final re-copy.

### CROSS-REFERENCE TO RELATED APPLICATIONS

This application claims the benefit of prior-filed provisional application No. 61/327,374, filed Apr. 23, 2010, which is hereby incorporated herein by reference in its entirety.

### INCORPORATION-BY-REFERENCE OF MATERIAL SUBMITTED ON ATTACHED MEDIA

Not Applicable

### TECHNICAL FIELD

The invention relates to automatic memory management, particularly to garbage collection, in data processing and distributed systems.

### BACKGROUND OF THE INVENTION

Modern garbage collectors scale well to memory sizes of several gigabytes. A well-known modern collector providing soft real-time operation (approximately 50 ms pause times) for fairly large memories is D. Detlefs et al: Garbage-First Garbage Collection, ISMM'04, p. 37-48, ACM, 2004, which is hereby incorporated herein by reference.

Another recent garbage collector is S. Liu et al: Packer: an Innovative Space-Time-Efficient Parallel Garbage Collection Algorithm Based on Virtual Spaces, IEEE International Symposium on Parallel&Distributed Processing, IEEE, 2009, which is hereby incorporated herein by reference.

In many applications it is desirable to obtain even shorter pause times. F. Pizlo et al: STOPLESS: A Real-Time Garbage Collector for Multiprocessors, ISMM'07, pp. 159-172, ACM, 2007, which is hereby incorporated herein by reference, describes a garbage collector for real-time applications with very short pause times, implemented using soft synchronization and using wide objects for copying. It uses a read barrier to coordinate access to old and new copies of objects. Various other modern concurrent real-time garbage collectors are described in F. Pizlo et al: A Study of Concurrent Real-Time Garbage Collectors, PLDI'08, pp. 33-44, ACM, 2008, which is hereby incorporated herein by reference.

The verb copy is used in this description mostly in its technical garbage collection sense, which usually includes the notion of moving (relocating) an object to a new location in memory by copying it and then eventually (not necessarily immediately) freeing the original.

A modern reference counting garbage collector is described in S. Blackburn et al: Ulterior Reference Counting: Fast Garbage Collection without a Long Wait, OOPSLA'03, pp. 344-358, ACM, 2003, which is hereby incorporated herein by reference.

Background information on garbage collection can be found in the book R. Jones and R. Lins: Garbage Collection: Algorithms for Dynamic Memory Management, Wiley, 1996, which is incorporated herein by reference in its entirety. The book provides a good overview of garbage collector implementation techniques, and is a widely used textbook in the art.

The following articles provide additional implementation details for generational and copying concurrent garbage collectors, and are hereby incorporated herein by reference:
D. Doligez and X. Leroy: A concurrent, generational garbage collector for a multithreaded implementation of ML, POPL'93, pp. 113-123, ACM, 1993
H. Azatchi and E. Petrank: Integrating Generations with Advanced Reference Counting Garbage Collectors, CC'03 (Compiler Construction), LNCS 2622, pp. 185-199, Springer, 2003.

Various alternative approaches to copying objects in real-time collectors are presented in the following patent application publications, which are hereby incorporated herein by reference:

US 2008/0281886 A1 (Petrank et al), Nov. 13, 2008 “Concurrent, lock-free object copying” describes, among other things, a relocating mechanism that moves an object by using a status field related to a data field, possibly in an interim (wide) object space, which is then copied to a to-space object.

US 2009/0222494 A1 (Pizlo et al), Sep. 3, 2009 “Optimistic object relocation” describes, among other things, a technique wherein memory accesses are monitored for a write to an object [that is being relocated], and if a write is detected during relocation, the relocation fails and the memory at the destination address is deallocated; but if no write is detected, the relocation succeeeds and the references are updated to point to the destination address. The aborted relocation may then be retried (to a newly allocated destination address).

US 2009/0222634 A1 (Pizlo et al), Sep. 3, 2009 “Probabilistic object relocation” describes, among other things, a method of relocating objects where the object relocation may mark the words of the object during relocation with a relocation value to indicate transfer to the destination memory without locking the threads. The threads may be configured to check the value in the source memory during object access, and to access the corresponding word of the destination memory if the source memory word comprises the relocation value.

A recent survey on reorganizing data structures, including a section related to garbage collection (especially as it relates to persistent object systems) is provided in G. Sockut et al: Online Reorganization of Databases, ACM Computing Surveys, 41(3), pp. 14:1-14:136, 2009, which is hereby incorporated by reference.

There is a strong need for a scalable, sufficiently real-time, concurrent garbage collector and components thereof. Copying objects efficiently in parallel with mutator execution is an important component in building real-time and distributed garbage collectors.

### BRIEF SUMMARY OF THE INVENTION

A first aspect of the invention is, in a computing system, a method of copying a set of objects, comprising:
allocating space for a new copy of an original object that is a member of the set of objects;
copying the original object to the space allocated for the new copy;
during the copying, tracking writes to the original object by mutators; and
re-copying the original object to the allocated address if the original object has been written into during copying.

In an advantageous embodiment of the first aspect the copying and re-copying take place during a garbage collection cycle and at least one mutator is executing concurrently with the copying, and the method further comprises updating all references to objects in the set of objects to refer to the corresponding new copies atomically with respect to mutators, and there is a final re-copy that is done atomically with the updating of references with respect to the mutators.

A second aspect of the invention is a computer program product stored on a tangible computer-readable medium operable to cause a computer to:
allocate space for a new copy of an original object that is a member of a set of objects to be copied;
copy the original object to the space allocated for the new copy;
track writes to the original object by mutators during the copying; and
re-copy the original object to the allocated address if the original object has been written into during copying.

In an advantageous embodiment of the second aspect the computer program product is further operable to cause the computer to track writes by mutators to an object being copied by another node in a distributed system, and in response to detecting a write to the object, send information to that other node indicating that the object has been written into, and is further operable to cause the computer to receive information from another node in a distributed system indicating that an object in the set has been written into by a mutator during copying, and re-copy the object in response to receiving such information.

A third aspect of the invention is a computing system comprising:
a means for allocating space for a new copy of an original object that is a member of a set of objects to be copied;
a means for copying the original object to the space allocated for the new copy;
a means for tracking writes to the original object by mutators during the copying; and
a means for re-copying the original object to the allocated address if the original object has been written into during copying.

In an advantageous embodiment of the third aspect of the invention the means for tracking writes uses a thread-local write barrier buffer for recording the writes, and the computing system comprises a means for reading tracked writes using soft synchronization.

Various embodiments of the invention provide important benefits over the known prior art (though not all possible embodiments necessarily provide all or any of the mentioned benefits, and there may be other benefits not mentioned here):
objects can be relocated in parallel with mutator execution without the use of costly atomic instructions
the need for a read barrier is avoided, improving application performance
mutators are better isolated from the garbage collector than in other known concurrent collectors (requiring less mutual synchronization and having fewer interdependencies), allowing the garbage collector and mutators to be optimized more independently
copy planning can be performed as a separate step running in parallel with mutators, enabling the use of more sophisticated clustering algorithms (which, in turn, may reduce the size of remembered sets and improve performance in distributed, persistent, and virtual memory environments)
objects can be promoted to popular objects in parallel with mutator execution
the copying method can be used in distributed systems (including those employing distributed shared memory and a global virtual address space), because of the loose coupling between mutators and the copier
objects can be migrated from one node to another in a distributed system.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages or provide any or all of the benefits noted in any part of this disclosure.

### BRIEF DESCRIPTION OF THE SEVERAL VIEWS OF THE DRAWING(S)

FIG. 1 illustrates a computing system embodiment of the invention.

FIG. 2 illustrates a garbage collection cycle in an embodiment of the invention.

FIG. 3 illustrates copying a subset of the live objects in an embodiment of the invention.

FIG. 4 illustrates re-copying in an embodiment of the invention.

### DETAILED DESCRIPTION OF THE INVENTION

The invention is illustrated in the context of an incremental concurrent garbage collector, where garbage collection and object relocation are performed concurrently with mutator execution. However, the invention is not limited to the illustrated embodiments or contexts, and may have other embodiments not illustrated herein.

It is to be understood that the aspects and embodiments of the invention described in this specification may be used in any combination with each other. Several of the aspects and embodiments may be combined together to form a further embodiment of the invention, and not all features, elements, or characteristics of an embodiment necessarily appear in other embodiments. A method, a computing system, or a computer program product which is an aspect of the invention may comprise any number of the embodiments, elements, or alternatives of the invention described in this specification. Separate references to “an embodiment” or “one embodiment” refer to particular embodiments or classes of embodiments (possibly different embodiments in each case), not necessarily all possible embodiments of the invention. The subject matter described herein is provided by way of illustration only and should not be construed as limiting.

### Illustrative Computing System/Apparatus Embodiment

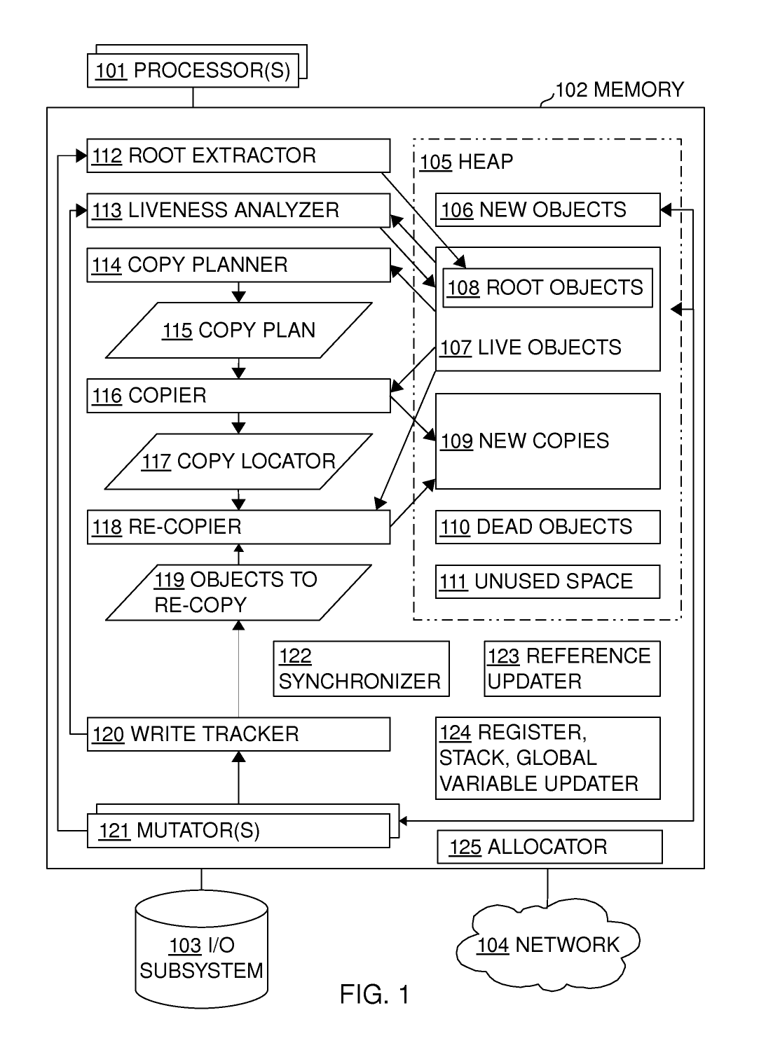

FIG. 1 illustrates a computing system and/or apparatus embodiment of the invention. The computing system comprises one or more processors (101) attached to a memory (102), either directly or indirectly, using a suitable bus architecture as is known in the art. The system also comprises an I/O subsystem (103), which often comprises non-volatile storage (such as disks, tapes, solid state disks, or other memories) and user interaction devices (such as a display, keyboard, mouse, touchpad or touchscreen, speaker, microphone, camera, acceleration sensors, etc). It often also comprises one or more network interfaces or an entire network (104) used to connect to other computers, the Internet, and/or to other nodes in a distributed computing system. Any network or interconnection technology may be used, such as wireless communications technologies, optical networks, ethernet, and/or InfiniBand®.

The processors may be individual physical processors, co-processors, specialized state machines, or processing cores within a single chip, module, ASIC, or system-on-a-chip. Preferably they are 64-bit general purpose processors, such as Intel® Xeon® X7560 or AMD® 6176SE, or more precisely cores therein. The memory in present day computers is typically semiconductor DRAM (e.g., DDR3 DIMMs), but other technologies may also be used (including non-volatile memory technologies such as memristors).

A computer may be any general or special purpose computer, workstation, server, laptop, handheld device, smartphone, wearable computer, embedded computer, a system of computers (e.g., a computer cluster, possibly comprising many racks or machine rooms of computing nodes and possibly utilizing distributed shared memory), distributed computer, computerized control system, processor, chip, or other similar apparatus capable of performing data processing.

A computing system may be a computer, a cluster of computers, a computing grid, a distributed computer, or an apparatus that performs data processing (e.g., robot, vehicle, control system, instrument, game, toy, home appliance, or office appliance). It may also be an OEM component or module, such as a natural language interface for a larger system. The functionality described herein might be divided among several such modules.

A computing system may comprise various additional components that a skilled person would know belong to such an apparatus in each application. Examples for various applications include sensors, cameras, radar, ultrasound sensors, manipulators, wheels, hands, legs, wings, rotors, joints, motors, engines, conveyors, control systems, drive trains, propulsion systems, enclosures, support structures, hulls, fuselages, power sources, batteries, light sources, instrument panels, graphics processors, front-end computers, tuners, radios, infrared interfaces, remote controls, circuit boards, connectors, cabling, etc. Various examples illustrating the components that typically go in each kind of apparatus can be found in US patents as well as in the open technical literature in the related fields, and are generally known to one skilled in the art or easily found out from public sources. Various embodiments of the invention can generally lead to improved user interfaces, more attractive interaction, better control systems, more intelligence, and improved competitiveness in a broad variety of apparatuses and systems, without requiring substantial changes in components other than the higher-level control/interface systems that perform data processing.

Various components relevant to one or more embodiments of the present invention that are illustrated in the figures may be implemented as computer executable program code means residing in tangible computer-readable memory, or fully or partly in hardware, for example, as a part of a processor, as a co-processor, or as additional components or logic circuitry in an ASIC or a system-on-a-chip. They may also be implemented using, e.g., emulation, interpretation, just-in-time compilation, or a virtual machine.

The heap (105) is a memory area used for storing objects that can be accessed (i.e., read and/or written) by mutators (121). A mutator is a thread (or other suitable abstraction) executing application code, and usually writing to (i.e., mutating) objects in the heap. Mutators may be implemented, e.g., as operating system threads time-shared on the processor(s), as dedicated processor cores, or as hardware or software state machines (possibly with stack). They may also employ emulation, just-in-time compilation, or an interpreter (as in, e.g., many Java virtual machines).

The heap comprises various sub-areas or regions in many embodiments. The term region is used herein to refer to a memory area that can be garbage collected independently of (most) other memory areas. New objects (106) illustrate a region where new objects are allocated by mutators (it may consist of several memory regions that are not necessarily contiguous and may be dynamically extended). In the description below, it also illustrates new objects created by mutators while the garbage collector is executing. This area is often called the nursery.

Live objects (107) illustrate objects that are (or may be) accessible (i.e., readable and/or writable) to mutators and may be read or modified by mutators (in addition to the new objects). In a distributed system some of the objects may reside on other nodes (i.e., on other computers that are part of the computing system), and there may be a copy of some objects on more than one node (i.e., they may be replicated). Some remote objects may be represented by stubs or delegates in some embodiments, as is known in the art.

The live objects include root objects (108), which are objects (potentially) referenced from global variables, registers, stack slots, and other memory locations that are inherently accessible. The root set, i.e., the set of root objects, is (conservatively) extracted at the start of each garbage collection cycle. Since the root and live object sets are conservative, they may sometimes include objects that are not actually reachable; however, the system tries to ensure that such objects eventually get freed.

The new copies (109) are copies of live objects made during garbage collection. They are normally not accessible to mutators, until the finalization phase described herein switches mutators to see (only) the new copies for the copied objects, at which time they become part of the live objects and their old versions normally become part of the dead objects.

The dead objects (110) represent objects that are known to no longer be accessible to mutators. Such objects can usually be freed. Usually any detected dead objects are freed before the end of each garbage collection cycle (making the space used by them free and part of the unused space).

The unused space (111) illustrates space in the heap that is currently unused. Such space can normally be used for allocation.

The heap may also comprise other data, including metadata (such as remembered sets, various bitmaps, or forwarding pointers) in some embodiments. In many embodiments the heap may also comprise special memory areas for popular objects, constant objects, or large objects.

The root extractor (112) illustrates a component that conservatively extracts the root objects (108) from the mutators and other data in the computing system. It may use, e.g., global variables, thread stacks, thread-local variables, remembered sets, scions, and/or external references reported by other nodes in a distributed computer system for identifying the roots. Any known method may be used for extracting roots, including, e.g., the sliding views method mentioned in Pizlo et al (2007).

The liveness analyzer (113) illustrates a component for determining which objects are live, that is, accessible from the roots (note that the set of root objects can be conservative, including objects that are no longer live, and so can the set of live objects). In many embodiments, a garbage collection cycle performs liveness analysis for only a fraction of the heap at a time. Such a garbage collector might select, for example, a set of regions to be copied (the regions of interest), and could perform liveness analysis for only those regions and the nursery. Other parts of the heap would then typically not be affected by the garbage collection, except for referring pointer update.

The liveness analyzer is advantageously implemented so that it does not clobber any live objects. The mutators may run concurrently with liveness analysis, and may access (including modify) the live objects during the liveness analysis. Mutators will execute faster if they do not need a read barrier, and therefore the objects are preferably not modified (in a manner visible to mutators) by the garbage collector during the collection. The liveness analyzer may, e.g., mark live objects in a bitmap or in a reserved space in an object header. Any known method may be used for liveness analysis.

The copy planner (114) illustrates a component for planning which objects to copy, where to copy them, and how to copy them. It may choose to copy some, all, or none of the objects of interest. Mutators execute in parallel with it, and continue to use the write barrier to track writes. In some embodiments, the copy planner may be combined with the liveness analyzer or the copier (116), especially if all objects included in the live objects set are to be copied and no clustering is done or clustering is very simple. In some other embodiments, the copy planner may be quite complex, using, e.g., a graph partitioning algorithm to divide the live objects into subgraphs that are each copied to a different region or node, or made a different distinguished subgraph, minimizing the number of connections between subgraphs.

When a separate copy planner is utilized, it may produce a copy plan (115), which is a data structure describing how the objects are to be copied. It may describe which objects are to be copied such that they form a cluster. It may also include a concrete destination address for each object (or a tree of objects; see U.S. patent application Ser. No. 12/147,419 “Garbage Collection via Multiobjects”) in some embodiments. The copy plan may be stored by storing forwarding pointers for the objects to be copied (note: they may not yet have been copied at this stage, and might use a separate indicator to indicate when they have been copied). In other embodiments, the copy plan might be stored as a table, possibly arranged according to the destination region where the objects are to be copied or by the source address of the object (thereby improving locality in copying and thus its performance, and allowing the copying to be performed by a processor core residing on the same NUMA (Non-Uniform Memory Access) node as one or both of the source and destination regions).

In many embodiments large objects are stored separately from other objects, and large objects are never moved. Thus, the copy planner would usually not include large objects in the set of objects to be copied.

If the liveness analyzer discovers trees of objects, such trees may advantageously be treated as single objects during copy planning in some embodiments. The copy planner could use the trees as the unit in graph partitioning, speeding it up significantly.

The copier (116) is a component for copying live objects to new locations in the address space (to new copies (109)). It generally follows the copy plan (115); however, in some embodiments it may be integrated into the liveness analyzer (113) or the copy planner (114). In some embodiments the destination addresses for copies are decided by the copy planner; in others, they are decided by the copier. Space for the new copies may be allocated by the liveness analyzer, the copy planner, or the copier. Allocating space for some or all of the copied objects before the copying begins allows all pointers in the new copies referring to copied objects to be updated to refer to the new copies already during copying.

The copier stores the new addresses of objects in the copy locator (117), which may be a separate data structure or, e.g., forwarding pointers for which space is reserved in the header of each object (or, equivalently, between objects). The copy locator may also be an array indexed by a value computed from the address of the object (e.g., “idx=(addr−base)/min alignment”), or a set of such arrays, one for each contiguous memory area from which objects are being copied. Such arrays could include, e.g., forwarding pointers (e.g., memory address of the corresponding new copy, with uninitialized values for slots that do not correspond to the beginning of an object), or offsets to an allocation memory area, or an allocation memory area identifier and offset within the area. For example, a region number or index into a separate allocation region array could be stored in the more significant bits and an offset in the less significant bits of a 32-bit value. Alternatively, a hash table or some other index structure could be used for finding the new address of an object from the address of the object (or from an address within it in some embodiments). It is also possible to use a different data structure for the copy locator in the nursery and in older regions (for example, using a forwarding pointer between objects in the nursery, and a per-region array for objects in older regions).

Those pointers within copied objects that refer to other copied objects are preferably updated during copying. For example, in embodiments where the destination address for each object is determined before copying, it is possible to iterate over each copied object, check for each pointer therein whether it points to another copied object (e.g., to a memory region included in copying), and if so, use the copy locator (117) to look up the new location of the referenced pointer. This could be done irrespective of whether the referenced object has already been copied, allowing very liberal parallelization of the copying. Such pointer updating could be done, e.g., after copying each object, or for a plurality of objects at a time after several objects have been copied, or for all copied objects at once after they have all been copied. It would also be possible to postpone such pointer update to a time when other referring pointers are updated.

In embodiments where the destination address for each copied object is only determined when it is copied, the copying could be performed recursively, using a stack, as is customary in many copying collectors (see the book by Jones and Lins for examples). The new addresses for the copied objects could then be stored in the copy locator (e.g., forwarding pointer in object headers) as each object is copied. Such copying would perhaps be best suited for copying integrated with liveness analysis, with little or no planning involved. Such copying would need to handle cycles and shared data, unlike copying that has been fully planned in advance and where destination addresses have already been assigned in the planning or liveness analysis stages (in those cases cycles and shared data checking has already been handled at that stage).

After the copying completes, the re-copier component (118) may be activated one or more times to re-copy those objects that have been modified during copying. Since only a small fraction of the copied objects is likely to be modified during copying, re-copying them should be much faster than the original copying. If some objects are again written during the re-copying, those can be re-copied again, but the set of objects to re-copy should now be even smaller, as the previous re-copying was presumably faster than the original copying. This may be repeated a few times.

The copy planner, copier, and re-copier advantageously run concurrently with mutators. While the copier (116) and re-copier (118) execute, a write tracker (120) is used for tracking (monitoring) which objects in the set being copied have been written into during copying, and those objects are scheduled for re-copy. The write tracker is advantageously implemented using a write barrier (most large-scale garbage collectors for general-purpose processors use a write barrier anyway).

The write barrier buffers are preferably thread-local, and are read using soft synchronizations. In a soft synchronization each mutator thread performs a specified function and then continues without requiring all mutators to stop simultaneously. Soft synchronization is complete when all mutators have performed the function (any available thread can be used for performing the function for mutators in blocking calls).

For reading the buffers, each mutator thread moves its buffer(s) to, e.g., a list that is accessible to the re-copier, and starts using a new empty buffer. Alternatively each mutator thread could iterate over its buffer(s), and add values to a re-copying queue (if not already there). However, such approaches are likely to require more synchronization than simply moving the old buffer(s) aside.

There are, however, also other possible ways of tracking (monitoring) writes. For example, a write barrier could be used for setting an indicator (e.g., status field) in the header of each modified object (possibly using atomic instructions to deal with race conditions), and the flag could be checked after copying. It would also be possible to implement the tracking using memory protections, e.g., by write-protecting all memory pages containing objects to be copied, and in a protection trap handler setting an indicator that the page has been written into, changing protections on the page to allow writes, and continuing. Then, all objects at least partially on the modified page could be assumed to have been modified and needing re-copy.

The advantages of using a write barrier with thread-local buffers for the tracking include low mutator overhead, and lower re-copying overhead because there is no need to iterate over all copied objects and the tracking is accurate (no need to re-copy all objects on a modified page). A major advantage is also that tracking using thread-local write barrier buffers scales to distributed systems more easily than the other known solutions.

The objects to re-copy (119) is any suitable data structure or arrangement for representing which objects to re-copy. The data structure may be, for example, a hash table interpreted as a set, a bit map, or collectively some indicators in object headers.

The synchronizer component (122) implements synchronization between mutator threads (121). Preferably, it implements soft synchronization, which is used by the root extractor, liveness analyzer, write tracker/re-copier, and for remembered set updating. It may also implement stop-the-world synchronization, e.g., for switching to use new copies of modified objects.

The reference updater component (123) is used when switching to use new copies of modified objects. It updates any pointers from outside the copied objects to any of the copied objects to point to the new copy of the object. It is preferably activated only when all mutator threads are stopped.

The register, stack, and global variable updater component (124) is also used when switching to use new copies of modified objects. It changes any references to the copied objects in thread registers, stack frames, global variables, or other protected locations to refer to the corresponding new copies.

The allocator (125) allocates space for the new copies of original objects that are to be copied. It may be part of the liveness analyzer, copy planner, or copier, or may be implemented as a stand-alone component. Any known method can be used for allocating space, including freelists, TLABs (Thread-Local Allocation Buffers), NEW pointers, and grouped space allocation. Grouped space allocation is described in the U.S. patent application Ser. No. 12/436,821 “Grouped space allocation for copied objects”, which is hereby incorporated herein by reference.

### Illustrative Process Steps for a Garbage Collection Cycle

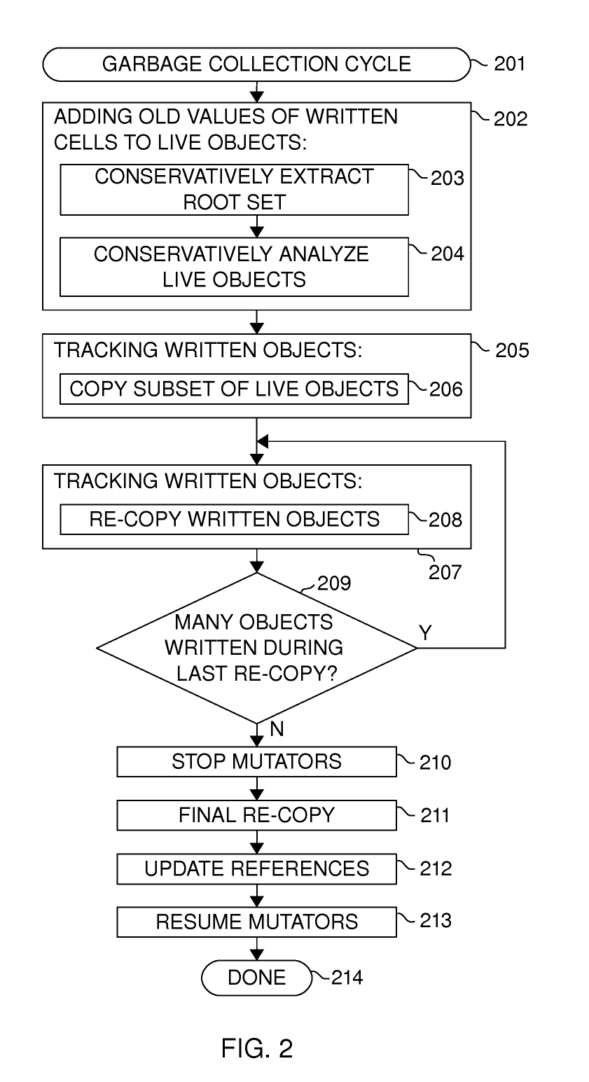

FIG. 2 illustrates the garbage collection cycle from a method perspective in an advantageous embodiment. Beginning of the cycle is illustrated by (201). As the garbage collection begins, all or some subset of the heap is selected for garbage collection (this subset is referred to as the regions of interest or objects of interest).

The box (202) illustrates extracting the root set and analyzing liveness of objects in the subset while using the garbage collector to collect old values of written memory locations. Step (203) illustrates conservative root set extraction by the root extractor (112). Step (204) illustrates conservative liveness analysis by the liveness analyzer (113).

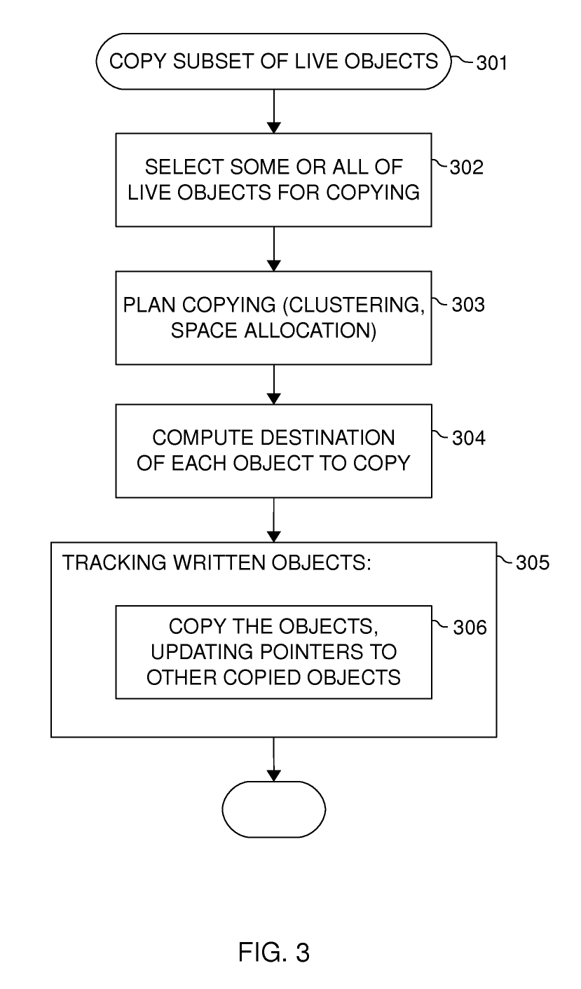

The box (205) illustrates copying objects while tracking which already copied objects are written into. The actual copying is illustrated by (206), and is further illustrated in FIG. 3.

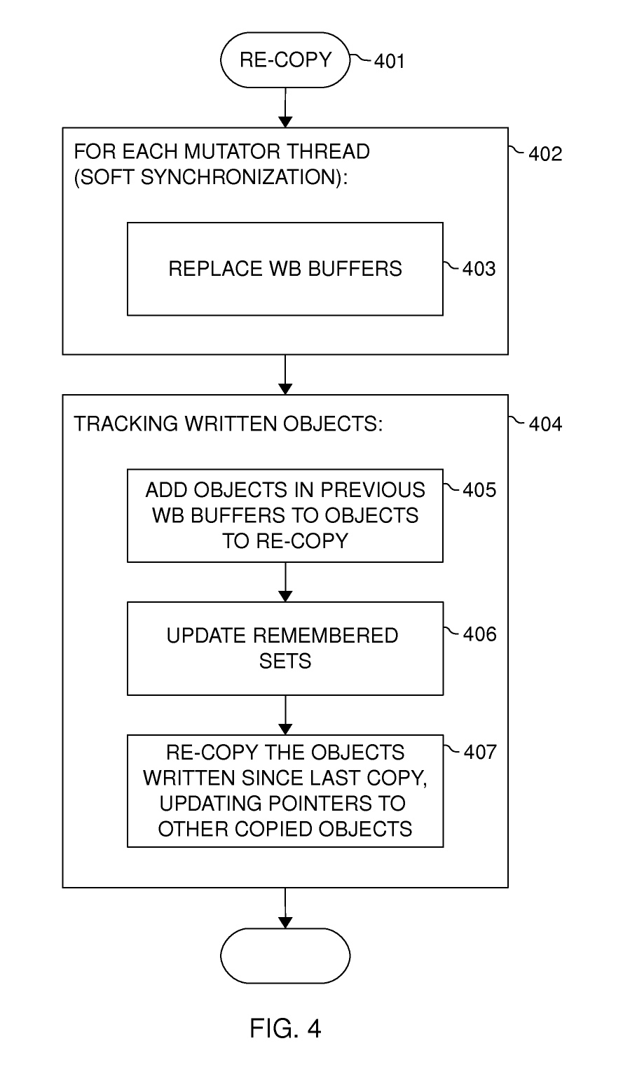

The box (207) illustrates re-copying objects that may have been written into since they were last copied, while tracking which already copied objects are written into. The actual re-copy operation is illustrated by (208), and is further illustrated in FIG. 4.

The test (209) illustrates checking whether another re-copying round should be performed. For example, no more re-copying should be done if any of the following is true:
the number and size of objects to re-copy is small (e.g., less than 20 objects and less than 10 kilobytes)
many of the remaining objects have already been copied more than N times (e.g., more than once) (such objects could also be postponed to last re-copy even if other objects continue to be re-copied)
re-copying has been done too many times (e.g., at least three times).

At (210) all mutators are stopped. It is known in the art how to achieve this, e.g., by setting a global variable that is checked by all mutators every time they enter a GC point, or by signalling an interrupt to all mutator threads.

At (211) a final re-copy operation is performed similarly to the previous re-copies (see FIG. 4); however, since mutators are now stopped, there is no need to track writes using the write barrier.

At (212) all references to the old copies of the copied objects are replaced by references to their new copies. This includes, among other things, thread registers, stack slots, global variables, any special data structures in the run-time system or virtual machine (for example, guard functions for objects needing explicit destructors). In embodiments where object references remain in write barrier buffers (e.g., for tracking changes for remembered set updating), they may need to be adjusted to refer to the new copies. Any remembered set data structures that include references to the old objects are updated to refer to the new copies (depending on how the data structures are implemented, this may also involve additional changes, such as moving metadata from the object's old region to a new region, or re-indexing some metadata entry).

At (213) the execution of mutators is resumed, and the garbage collection cycle is complete at (214).

### Mutators and the Write Barrier

When a thread writes to a memory location, most large-scale garbage collectors use a write barrier to track which memory locations have been written. In some systems the write barrier tracks writes only coarsely, such as on a per-page granularity (typically 4096 bytes) using memory protection traps or per-card granularity (typically 512 bytes) using card marking. Some systems log all written addresses in log buffers (write barrier buffers), possibly with some filtering of duplicates. Some systems update hashtable-based remembered sets directly from the write barrier. Various combinations of the techniques can also be used, including using a combination of card marking and log buffers with a background thread for processing the buffers (e.g., Detlefs et al (2004)).

Hash table based write barrier buffers have been described in the co-owned U.S. patent application Ser. Nos. 12/353,327 “Lock-free hash table based write barrier buffer for large memory multiprocessor garbage collectors” and 12/758,068 “Thread-local hash table based write barrier buffers”; these are hereby incorporated herein by reference. Thread-local hash table based write barrier buffers are particularly advantageous, as they can be maintained by mutator threads without using any atomic instructions in the write barrier. They can also be easily expanded when needed, without blocking any other mutators, and usually eliminate duplicate entries.

For remembered set updating it is generally sufficient to track writes to cells that can contain pointers, but for re-copying purposes the write barrier should track also writes to memory locations that cannot contain pointers (e.g., floating point fields in structures). One possibility is to have two different write barriers, one for pointer types, and another for non-pointer types. A compiler can be used to combine multiple invocations of the non-pointer write barrier for the same object into a single invocation. Also, it may be desirable to store the address of the written object, rather than the address of the written cell, with the write barrier used for re-copying. The re-copying write barrier would do nothing except when copying/re-copying is active.

When thread-local hash table based write barrier buffers are used, two separate write barrier buffer hash tables can be allocated for each thread. One hash table is used for collecting updates to the remembered sets. It is keyed by the address of the written cell, and stores the old value that the cell had when the write occurred as the value of the key.

The other hash table is used for tracking which objects have been written into during copying, and tracking the old values of cells written during root extraction and liveness analysis. However, either or both of these functions may also be performed using the first hash table; it already includes the old values. If it is possible to find the object header quickly from an address within an object (many systems using card marking based write barriers already support this), then it can be used for finding the objects that have been written into during copying/re-copying (writes to non-pointer fields would also need to be added to the hash table during copying/re-copying, with, e.g., NULL pointer as their value). Old values could be obtained directly from the hash table. Whenever reading old values (in soft synchronization for each thread), the hash table would preferably be moved aside and a new hash table allocated; a background thread (such as the liveness analyzer) would then take the saved hash table, iterate over old values therein, pushing roots for old values of interest, and saving the buffers for use in the next remembered set update (or performing remembered set update immediately). Such a system could have a freelist for write barrier buffer hash tables and could clear the hash tables during iteration.

Various other alternatives also exist for tracking which objects have been written. For example, the distributed shared memory literature from the mid-1990s contains many articles describing methods of implementing fine-grained tracking and distribution of object changes, ranging from solutions similar to a write barrier to using memory protection traps to track the written locations to computing a “diff” (difference) between the original version of a page and the final version of the page. A person skilled in the art should be able to adapt these methods, and various other methods, for tracking the writes. Also, write barrier techniques need not necessarily use hash tables or log buffers; for example, one could have a bitmap associated with each memory region in which objects being copied are stored, with one bit in the bit map for each address that can start an object (e.g., one bit per 16 bytes), and the write barrier could just set the bit corresponding to the written object to one (i.e., something like “bitmap[(addr−base)>>6]|=1LL<<((addr−base) & 63)”, possibly using an atomic instruction). A bit in the header of each object could also be used.

In embodiments where only those fields of objects are re-copied that have been written into, the write barrier should track each written memory address separately. It could, for example, record for each written field its memory address (or object address plus field offset, index, or other identifier) and the size of the field.

Threads that have informed the garbage collection system that they are in blocking calls are handled specially. Any available thread may be used for performing the synchronization operation (calling the relevant function) on their behalf. They should also be prevented from resuming after the blocking call before the synchronization operation for them is complete. They can be handled analogously for stop-the-world synchronization, as is known in the art (for example, the widely known, open source Jikes RVM implements similar operations using the setBlockedExecStatus( ) function).

As the write barrier records written memory addresses (or object pointers), and possibly the old values of written memory locations, it may perform filtering on the writes as is known in the art (i.e., it will not record all writes). Frequently used filtering criteria include the following:
writes to (new) nursery usually need not be recorded
writes whose values are non-pointers, constants, or popular objects need not be saved in many embodiments
writes whose values are younger than the written object often need not be stored (generational collectors, train collectors).

The write barrier is usually designed to minimize the number of instructions performed in the fast path (the most typical case). Typically write barrier instructions are ordered such that the average number of instructions is minimized, and the application's memory map is designed in such a way that as many tests as possible can be performed simultaneously or with as simple instructions as possible, as is known in the art.

Frequently, testing whether the address being written into is something that needs to be saved is done by a comparison similar to

if (((unsigned long)addr − (unsigned long)old_heap_start) <

old_heap_size)

perform_other_tests_and_save_if_appropriate( );

If more than one nursery is used, implementing filtering using address comparisons may not be sufficient. In such embodiments (assuming a memory organization based on fixed regions stored contiguously in memory at addresses that are multiples of their size), using a bitmap to track which regions are to be treated old regions may be useful. In such embodiments, the following code snippet illustrates one possible way of implementing the filtering (this is for 64-bit machines; the constants on the second line will be 5 and 31 for 32-bit machines):

int regidx = (addr − region_base) >> log2_of_region_size;
if (old_region_bitmap[regidx >> 6] & (1L << (regidx & 63)))

perform_other_tests_and_save_if_appropriate( );

In such embodiments, the bitmap could be updated before the first synchronization and possibly (depending on the memory consistency model of the underlying platform) using a memory barrier instruction during the synchronization operation to ensure that all threads have started using the updated bitmap (this possibly results in some extra writes being recorded to the write barrier buffers, but they can be filtered when processing the buffers), or it could be made thread-local, and updated during the first synchronization.

A similar bitmap could also be used for quickly identifying which writes are to regions in which objects being copied are stored. When recording written objects for re-copying, such a bitmap could be used to avoid recording written objects that are not in the area being copied.

Another possible approach for implementing the write barrier is illustrated by the code snippet below. This approach is based on having a table describing the status of each region (here called ‘status[ ]’, with 0 indicating new nursery region, 1 old nursery region or old region from which objects are being copied, 2 any old region that is not being copied, and 3 popular object/constant region):

int addr_idx = (written_addr − regions_base) >>

region_size_shift;

int st = status[addr_idx];
if (st == 1) /* write to object being copied? */

record_written_object(written_obj);

int value_idx = (new_value − regions_base) >>

region_size_shift;

int valst = status[value_idx];
if (st == 0) /* write to new nursery? */

{

if (valst == 1)

record(written_addr, NULL);

return;

}

/* write to old region */
int oldvalue_idx = (old_value − regions_base) >>

region_size_shift;

int oldvalst = status[oldvalue_idx];
if ((valst != 3 && addr_idx != value_idx) ||

oldvalst != 3)

record(written_addr, old_value);

In this sample write barrier illustration, record( ) adds the address to a thread-local write barrier buffer if it is not already there, with the second argument as its value. If the address is already there, its value is not changed. ‘written_addr’ is the address being written, ‘written_obj’ the object containing that address, ‘new_value’ the new value being written to the address, ‘old_value’ the old value of the address, ‘regions_base’ the address where the first region starts (which must be a multiple of region size), and ‘region_size_shift’ is base-2 logarithm of the size of a region. All regions are assumed to be of the same size (which must be a power of two).

The record written object( ) action adds the written object to a separate write barrier buffer. It is used for tracking which objects being copied have been written into during copying. This action should be performed also for non-pointer writes (e.g., for fields containing raw floating point numbers). The compiler would advantageously eliminate redundant multiple calls for the same object between GC points, as is known in the art.

Non-pointer values were not handled above, but should be treated as having ‘valst’ 3.

For global variables, a similar write barrier can be used, always treating global variables as having ‘st’ 2 and ‘addr_idx’ different from any normal region.

These write barrier implementations are just illustrative, and many other kinds of write barriers could be used. For example, filtering could be done using address comparisons instead of arrays of region statuses. The region status arrays could be, e.g., character arrays, or could use two bits per region (in which case they could be 64-bit unsigned integer arrays, and accessing them could be something like “(status[(2*idx)>>6]>>((2*idx) & 0x63)) & 3”. The status could also be encoded in bit vectors, and accessed using special bit vector accessing instructions (e.g., the x86-64 architecture (Intel, AMD) has such instructions).

In some embodiments the write barrier might also be implemented directly in hardware (possibly as an extension to the instruction set of the processor(s)). Several hardware-based write barrier implementations have been described in the garbage collection literature over the past three decades.

When a thread reads a memory location on the heap (or a global variable), some systems employing garbage collectors use a read barrier to ensure consistency, particularly when objects are moved concurrently with mutator execution. Using a read barrier typically causes significant overhead to application execution, costing several percent of total execution time of an application (possibly more, possibly less, depending on the application). Various embodiments of the present invention can advantageously be used without a read barrier. Nevertheless, using a read barrier, as described in the book by Jones and Lins and in the incorporated references, is possible in some embodiments of the invention.

### Copy Planning & Copying

FIG. 3 illustrates copy planning and copying in an embodiment of the invention.

At the beginning (301), liveness analysis (and root extraction) is complete. It is no longer necessary to track old values of written memory locations in mutators (unless such tracking is needed for remembered set maintenance).

At (302), some or all of the (conservatively) live objects are selected for copying (they are also called herein the objects to copy or the copied objects).

The step (303) illustrates copy planning and space allocation. Many systems have no separate copy planning step, and the space allocation may also be performed while copying (or during liveness analysis). A separate copy planning step may, however, be useful in systems with large memories, in distributed systems, or in persistent object systems. In such systems the object graph is very large, and clustering (memory locality) issues become important. The better objects referencing each other are clustered together, the smaller the remembered sets in the system will be. Also, if long-lived objects are clustered into one region, and short-lived ones into another, overall garbage collection efficiency will be improved, because the region containing long-lived objects will not need to be garbage collected again for a long time.

The copy planning stage may also detect that some objects have existed for a long time and/or are referenced from many places, and therefore should be made popular objects (for which remembered sets are typically not maintained). The copy planner may then allocate space for such objects from a special popular object region (references to objects in the popular object region are not be included in remembered sets). Such an embodiment provides a means for promoting normal objects to popular objects concurrently with mutator execution.

The copy planning step basically takes as input the set of live objects of interest (or set of groups, such as tree-like subgraphs, of such objects), and assigns a cluster tag, region identifier, or destination address for each object (or group of objects). When it directly assigns a destination address, it is performing allocation directly during the copy planning step. When it only assigns a cluster tag or region identifier, allocating space may be performed later, e.g., as the objects are copied. Grouped space allocation may be advantageously used for allocating space for an entire cluster of objects at a time. Various clustering criteria and methods are discussed in U.S. patent application Ser. No. 12/464,231 “Clustering related objects during garbage collection”.

The input data structures for copy planning may be constructed already during liveness analysis, or they may be constructed as a separate step before or during copy planning.

A trivial copy planner simply divides the objects into regions. It may iterate over all objects to be copied in some arbitrary order, and as long as space remains in the current region, assign the object to that region. When no more space remains, it allocates a new region and assigns the object to that region.

A more sophisticated copy planner may use a graph partitioning algorithm, such as the one described in C. M. Fiduccia and R. M. Mattheyses: A Linear-Time Heuristic for Improving Network Partitions, 19th Design Automation Conference, pp. 175-181, IEEE, 1982, which is hereby incorporated herein by reference. The graph partitioning algorithm is designed to approximate dividing the set of objects into partitions such that as few connections (pointers) as possible cross partition boundary. An arbitrary set of objects may be divided into regions by recursively dividing the set of objects to copy in half, until the total size of objects in each partition is smaller than the size of a region.

The graph partitioning approach may also be used for the construction of distinguished subgraphs (see U.S. patent application Ser. No. 12/489,617 “Copying entire subgraphs of objects without traversing individual objects”), dividing until the size of each partition is smaller than the maximum size of a distinguished subgraph. It is also possible to assign different weights to different connections, and to add connections to outside objects (e.g., clusters) to further influence the partitioning while still using the same partitioning algorithm.

The term “cell” is used in this document mostly in its conventional garbage collection or Lisp meaning (basically just meaning a memory location, usually in the heap; however, there is the added connotation that cells can contain pointers and/or tagged data in systems that use tag bits). In contrast, the paper by Fiduccia et al uses the term “cell” to refer to a vertex of a graph, or the smallest unit that can be moved from one partition to another (roughly corresponding to a component in CAD layout problems and an object or group of objects herein).

The step (304) illustrates computing a destination address for each object to copy, and setting up the copy locator (117) data structure. The copy locator provides an efficient means for finding the destination address for each object to be copied (i.e., the address at which its new copy will reside). A very simple implementation for the copy locator is a forwarding pointer in object headers. If the copy plan includes the destination address (i.e., the location of the new copy) for objects to be copied, then the copy plan can serve as the copy locator.

The box (305) illustrates actions that are to be performed while tracking which objects are written into.

Step (306) illustrates copying the selected objects, and updating pointers to other copied objects. More than one thread may be used for the copying. If destination addresses have already been allocated before copying, it is easy to parallelize the copying by dividing the work (objects) into suitable chunks, and having each thread process a chunk object-by-object, doing the following for each object in the chunk:
look up the destination address for the object
copy the object to the destination address, and
update pointers in the object using information from the copy locator.

There is basically no synchronization needed between the threads (except for obtaining the next chunk). The copy locator is only read at this stage, so no synchronization is needed for accessing it.

However, copying may also be performed in other ways, including in conjunction with liveness analysis. If copy planning is done for groups of objects (e.g., tree-like subgraphs), then such groups might be traced at this stage (similar to multiobject construction in U.S. Ser. No. 12/147,419).

On NUMA (Non-Uniform Memory Access) machines it may be advantageous to allocate each region from a particular NUMA node, and use a thread executing on that NUMA node for copying objects into that region, thereby reducing load on the interconnection fabric between processors.

Copy planning is typically performed by the copy planner (114), producing a copy plan (115). The copying is then performed, based on the copy plan, by the copier (116), which produces a copy locator (117), which in turn will be used by the re-copier (118). However, it is possible to practically eliminate the copy planner, integrating copying decisions into the liveness analyzer (using a trivial policy, such as “copy everything to the next available free memory address”). Copying could be performed fully or partially already during liveness analysis. Some embodiments might have no explicit copy plan (especially if copying is performed already during liveness analysis).

How to copy objects is well known in the art, and the book by Jones and Lins describes various copying garbage collectors. In embodiments without a copy planner, almost any copying garbage collector algorithm could be used for the copying, with the addition that the destination addresses of copied objects are stored in a copy locator (e.g., a hash table), and using a write barrier for tracking writes to copied objects and a re-copier for re-copying those objects that were written into during copying.

With a separate copy planner, copying is further simplified; the following pseudo-code illustrates one possible implementation:

for (int i = 0; i < plan.num_objects; i++)

{

Object obj = plan.originals[i];
memcpy(plan.destinations[i], obj, plan.sizes[i]);
for (int j = 0; j < plan.sizes[i]; j++)

if (offset j in object contains a pointer)

if (obj[j] points to a copied object)

{

Object referenced_object = obj[i];
obj[j] = referenced_object.destination;

}

}

In this code, ‘plan’ refers to a copy plan, and ‘referenced_object.destination’ refers to the new location of the object (here, the ‘destination’ field would be, e.g., a forwarding pointer in object header); however, the new location could also, e.g., be looked up from a hash table. Determining whether something points to (the original of) a copied object can be done, e.g., by comparing the address of the object against the addresses of regions being copied, by looking up the region in which the object is stored from a region status array and checking the region's status, or by looking the object up from a hash table containing (pointers to) all copied objects (and if not found, concluding that it is not being copied).

If copy planning works on the level of trees of objects, there could be a bitmap indicating which objects in each region being copied have more than one reference (see ‘multiobj_start_bitmap’ in U.S. Ser. No. 12/147,419). In such embodiments, the size in the copy plan would be the total size of the objects in the tree-like subgraph (or multiobject). If any writes occur to the tree-like subgraph before it is fully copied, the cells that have been written are marked in a special write bitmap. Copying the tree can be implemented by a traversal that never recurses into an object that is marked in the ‘multiobj_start_bitmap’ (except, of course, for the root of the tree), and never follows a pointer in a cell that has been marked as written. Alternatively, a traversal that follows the original values of the objects could be used for copying such trees (similarly to the methods used in the U.S. patent application Ser. No. 12/201,514, filed Aug. 29, 2008 “Determining the address range of a subtree of a linearized tree” for accessing the original values of written cells).

During copying (and re-copying), mutators only see the original object, not the new copy. This allows the read barrier to be eliminated and simplifies the write barrier, because there is no need to decide on a per-access basis which of the original and new copies is to be accessed. In an advantageous embodiment, all references to the original objects are replaced by references to the new copies before any mutator accesses a new copy; when a mutator can access a new copy, it can no longer access the original object.

### Re-Copying

Since there is no synchronization between copying and mutators, each new copy may or may not represent the current version of the corresponding original object in the heap after copying. However, only a small fraction of objects is usually modified in any short time span, and thus only a small fraction of the copied objects is likely to be out of date. The idea of tracking which objects have been written into during copying (whether during the original copying or during re-copying) is that we can then re-copy those objects, bringing the copy up to date. Alternatively, it is possible to re-copy just the modified fields in the written objects, essentially propagating the write to the new copy.

However, additional modifications may occur during the re-copy. Since only a small fraction of copied objects normally need re-copying (the objects to re-copy (119)), the re-copy operation is normally much faster than the original copying, and therefore fewer objects are likely to have been modified during the re-copy than the original copy. Thus, repeating the re-copy two or a few times, the number of remaining objects to be re-copied is likely to be very small.

A final re-copy can be done during the finalization stage atomically with switching mutators to use the new copies (i.e., updating referring pointers). Doing it atomically (with respect to the mutators) means that to mutators it seems as if the last re-copy and switching to new copies occurred instantaneously. No mutator will see a mix of references to both the original objects and the new copies; therefore, they do not need to use a read barrier to coordinate access. (There are, however, other possible embodiments where a read barrier is used, e.g., during the last re-copy and while updating referring pointers to eliminate the need for switching them atomically.)

FIG. 4 illustrates re-copying. The re-copying operation starts at (401), usually after copying is complete (though it is possible to start re-copying even before all objects have been copied). Re-copying is normally performed by the re-copier (118).

The box (402) illustrates actions performed by each mutator thread, preferably using a soft synchronization (i.e., not all mutators need to perform them at the same time). Basically, in this box each mutator thread replaces its write barrier buffers (403), by saving its current buffers (both those used for tracking writes for remembered set updates, and those used for tracking which objects have been modified during copying) in a list (perhaps two separate lists), starts using new buffers, and continues. The write barrier continues to track writes, both for remembered set updating purposes and for tracking which objects (in the set being copied) are written into. It would also be possible to process the buffers here, but to keep mutator pauses short they are advantageously performed in (404).

The box (404) illustrates that actions therein are performed while tracking which objects are written into (and in most embodiments, also tracking writes for remembered set updating purposes).

At (405), objects in the saved write barrier buffers used for tracking which copied objects have been written are added to a set of objects to re-copy.

At (406), remembered sets are updated based on the saved write barrier buffers used for tracking writes for remembered set updating purposes. It would not be necessary to do this here, and such updating could be postponed until later (e.g., to the finalization stage), and not all possible embodiments use remembered sets. The remembered set updating may also be done in parallel with (407).

At (407), those objects that have been modified since last copy are re-copied, and any pointers in them referring to other copied objects are updated to refer to the new copies of such objects. Alternatively, this could also be implemented by copying only those memory addresses that have been written.

In some embodiments the re-copying may be augmented by detecting frequently updated objects, and postponing re-copying them to the finalization stage. For example, a flag (e.g., in the object header or in a separate bitmap) could be used for indicating that the object has already been re-copied once, and if it would need to be re-copied again, its second re-copy could be postponed to the finalization stage.

Tracking the number of copies could be done, e.g., by reserving space for a counter in the object header (one or two bits would probably suffice), or by using a hash table to track which objects have already been re-copied (adding each object to the hash table when it is re-copied, and possibly keeping a count as the value corresponding to the object in the hash table). Any count in the object header could share the same word with a forwarding pointer and a liveness indicator (the bits could be, e.g., stored in the lowermost bits of the forwarding pointer if objects are guaranteed to be aligned at, e.g., 8 or 16 byte boundaries; these bits would be masked away when the forwarding pointer is used).

Preferably, the re-copier re-copies the object to the same destination address to which it was originally copied. Such copying is advantageous, because then referring pointers in the copied objects to other copied objects can be updated to point to the new copies already during copying, reducing the duration of the final referring pointer update (which in some embodiments is performed during a stop-the-world pause). However, in other embodiments it would also be possible to free the old destination address (or just leave it unused as garbage), and allocate a new destination address for the re-copy. In such embodiments updating referring pointers within copied objects to other copied objects might best be delayed until other referring pointers are updated.

### Finalization

The finalization phase is used for atomically (with respect to the mutators) switching to use the new copies of the copied objects. If a read barrier was used, there would be no need to make this change atomic, as then all reads and writes occurring in this stage could be re-directed to use the new copies, and updating thread state and global variables could be performed using soft synchronization and concurrently with mutators. Since a read barrier incurs a significant overhead on program execution time (and power consumption in mobile devices), it is preferable to avoid the use of a read barrier. Most applications can tolerate a short pause in mutator execution, and even stopping all mutators (a stop-the-world pause) is quite fast on modern computers (probably on the order of tens of microseconds—note that threads already in blocking calls do not need to be waited for).

It is, however, important to minimize the duration of any stop-the-world pause (i.e., the time when mutators are stopped). As much work as possible should be performed outside the pause, and only a minimum amount during the pause. It may also be desirable to do as much precomputing as possible before the pause, such as dividing work into chunks that can be performed by separate threads—for example, remembered sets could be traversed and addresses to be updated divided into chunks based on their locality or NUMA node, leaving only a small remainder to be processed ad-hoc during the pause.

Step (210) in FIG. 2 illustrates stopping all mutators. Mutators in blocking calls, however, can continue to execute those blocking calls as long as they are prevented from returning to garbage-collected code before the pause is over. Blocking calls may also be lengthy computations, such as image processing actions or FFT (Fast Fourier Transform), that are often implemented as C language or assembly language libraries. Such operations may continue to execute in parallel with the stop-the-world pause if they are treated as blocking calls. (Blocking calls are typically not allowed to access any objects that might be moved, and are usually not allowed to mutate the object graph in any way.)

Step (211) illustrates a final re-copy, ensuring that all new copies of copied objects are up-to-date. Since mutators are stopped, it is not possible that there would be any updates to such objects during this final re-copy, and it thus happens atomically with updating the referring pointers, with respect to the mutators. Also, step (403) may be implemented by just taking the buffers from the mutators, since they are already stopped, and no writes to the copied objects can occur in (404) because the mutators are stopped. Step (406) illustrates a final update of the remembered sets.

Step (212) illustrates updating references to the copied objects. Any pointers (accessible to mutators) that refer to the copied objects are changed to refer to the corresponding new copy in each case (e.g., looking up the location of the new copy from the copy locator (117)).

After updating the referring pointers, the execution of mutators is resumed (213).

It is possible to parallelize some of the operations performed during finalization. For example, each mutator thread could update its thread-local slots as soon as it detects that it should stop for finalization, thereby performing these updates in parallel by the mutator threads. Global variable update can begin as soon as the last mutator (excluding mutators in blocking calls) stops executing normal mutator code. Remembered set updating can begin as soon as the first mutator stops for finalization. If the references via remembered sets have been precomputed, updating the precomputed addresses can begin as soon as the last mutator stops for finalization (assuming the updater checks that memory at each address still contains a pointer to a copied object), and any new referring pointers added in the last remembered set update (during finalization) can then be processed separately as soon as remembered set update is complete.

At the end of the finalization, the old nursery is unused and can be freed. Also, any regions that became empty as a result of moving objects away from them (by copying) can be freed. This completes relocating the copied objects.

In some embodiments, switching to use the new copies may be performed without a stop-the-world synchronization. In such embodiments, mutators may switch to using the new copies at different times, and it may be advantageous to propagate any writes to the new copy back to the original object during the time period after the last re-copy and before all mutators have fully switched to using the new copies. Such propagation may be a key element of a complete method for switching to use the new copies atomically without stopping all mutators simultaneously. The propagation may be implemented by looking up the original object based on the new copy from, e.g., a hash table where they are indexed, and writing the same value to the same address in the original copy.

Additionally, such propagating may be advantageously combined with the implementation of a distributed mutual exclusion lock with fine-grained synchronization of any updates occurring while the lock is held between nodes. Since mutators would normally use a lock (mutex) for synchronizing access to a memory location, no mutator should read the value of the memory location before obtaining the mutex that protects it. It is then sufficient to propagate any write to the new copy back to the original copy (and any write to the original copy to the new copy) before any other thread obtains the mutex. The write barrier can be used to track writes that occurred while holding a mutex, and the mutex implementation can ensure that all such writes have been propagated to the other copy before allowing any other thread to obtain the mutex (a simple way to ensure this is to propagate them when releasing the mutex). When the written value refers to one of the copied objects, it needs to be mapped during propagation so that the original objects only refer to original objects and new copies only refer to new copies (and objects that were not copied). Once all mutators have switched to using the new copies, mutators have ceased accessing the original objects and propagating can be stopped.

### Implementation as a Distributed Garbage Collector

Some embodiments of the garbage collector described herein can also be adapted to distributed garbage collection, especially for systems utilizing distributed shared memory (i.e., where all nodes share the same virtual address space and identify an object using its virtual address, as opposed to systems using stubs, scions, and/or delegates for distributed objects).

A “node” refers to a (non-distributed) computer that is part of a distributed computer. Each node may have several processors connected by (hardware-based) shared memory (possibly using a NUMA architecture). There is no (hardware-based) shared memory between nodes (or if there is, it is significantly slower to access than the memories internal to a node).

A distributed system is a kind of distributed computer, which is a kind of computer. Typically nodes in a distributed system access parts of the same data set (e.g., a knowledge base) and/or work co-operatively on the same problem or the same user request(s).

The term “NUMA node” is different, and refers to a subdivision of main memory having uniform access time characteristics (typically each NUMA node being “closer” to some processing cores than others, e.g., reflecting the difference between memory connected directly to a processor chip vs. memory connected to another processor chip and accessible through an interconnection fabric between the processors).

This description assumes reliable communications between the nodes, and that packets sent by a node are received by each recipient node in the order in which they are sent. Implementation of such communications protocols is known in the art of distributed computing.

Applications in semantic information processing, semantic search, social networks, and in general large knowledge processing systems are likely to have extremely large knowledge bases (many terabytes, or even petabytes; many billions of objects). It is not practical to use delegates, stubs, and/or scions for remote objects in such systems. Instead, it is important to be able to replicate objects, migrate them between nodes, and to perform garbage collection efficiently in such a system.

The garbage collection method described in FIG. 1 can be adapted for distributed garbage collection as follows (several other alternative embodiments can also be recognized by one skilled in the art).

Each region is associated with a home node that has an authoritative copy of the region (in a fault tolerant system, this would be a set of nodes each of which has an authoritative copy). It is assumed that each node is capable of mapping a memory address to a region and to a node number (the node number could be stored in an array indexed by a region number, or could be determinable from the memory address, e.g., by letting higher-order bits of the region number be the node number).

Each node is assumed to have its own nursery regions (however, the nursery regions may be accessible to other nodes).

Each node maintains remembered sets of references to each of its regions. Such references may be from objects in its local regions, or from regions at remote nodes. In each case, the referring node can be determined from the address of each referring pointer in the remembered sets.

Whenever remembered sets are updated locally on a node based on data collected by its write barrier, any updates to remembered sets of regions on remote nodes are sent to the home node of the region. At certain points (as described below), certain synchronizations are used to ensure that all updates have been properly received and processed. (It may also be advantageous for all nodes that have a copy of a region to maintain remembered sets for it.)

When a garbage collection cycle starts, all nodes are notified of the start of the cycle. Each node then begins extracting roots and performing liveness analysis. If any remembered set updates are received during this time, any new remembered set entries pointing to objects of interest are added as roots (in addition to being processed normally as remembered set updates). Each node acknowledges to the node sending the remembered set update when the update has been processed (by sending a suitable message to it).

When a node completes liveness analysis (its stack is empty), and has received acknowledgements for all remembered set updates it has sent so far, it sends a message to all other nodes (possibly using a broadcast/multicast) to that effect. If it later receives a further remembered set update that introduces a new root, it will send a notification about continuing to all other nodes and continue liveness analysis.

If a node has itself completed liveness analysis, and has received a notification from all other nodes that they have completed liveness analysis (without later notifications about continuing), then all nodes have completed liveness analysis (reaching the end of box (204)).

Each node will select its own nursery regions as the regions of interest. Additionally, each node may select one or more regions owned by itself or by other nodes for collection. (It is also possible to only select some objects from a region.) No two nodes must select the same object (i.e., if two nodes select from the same region, they must select different objects).

One way to select the regions is for each node to select only regions whose home node it is. However, this does not support migration. One way to negotiate migration is to send a request to a region's home node requesting that the requester be permitted to collect that region. The home node may then grant or reject the request, or grant it partially (for some objects; the request could also be only for some objects). The request and response could be sent during root extraction and liveness analysis, or it could have been sent even earlier (before the garbage collection cycle began), requesting permission for the next garbage collection cycle. A home node might also propose migration to another node (e.g., because most references in the region's remembered set are from that node), and the other node could accept or reject the migration request.

Object migration is thus implemented by allocating space for an object from the node performing the copying, which is a different node from the home node of the original object. (In am alternative embodiment the object could be copied from the node doing the copying to another node.)

It is assumed that each region being collected that is owned by a remote node will first be copied as-is (i.e., replicated) to the node that is going to collect it, if it does not already have a replica. The replica might be sent immediately after accepting/granting permission to copy the region. Collection should not start until data for the region has been received.

The region may be transmitted over the network in compressed form, and only those objects that were marked as live in the last global tracing need to be transmitted (unless objects have been added to the region since the last global tracing). The techniques described in the U.S. patent application Ser. No. 12/360,202 “Serialization of shared and cyclic data structures using compressed object encodings” may be used for the compression, with pointers pointing out from the region encoded as-is, or, e.g., by reference to a previously sent pointer value.

Note that mutators on any number of nodes may be using (reading, writing) regions that are being garbage collected, simultaneously with the collection, each using its own replica of the page. (To implement distributed shared memory, various mutual exclusion and memory barrier techniques are likely to be used, with fine-grained or coarse-grained synchronization of updates, as is known in the art. Extensive published research relating to distributed mutual exclusion and consistency issues in distributed shared memory took place in the mid-1990s.

The nodes will advantageously be made to share information about all the regions being collected by any node (in part, e.g., by broadcasting the answers to requests/proposals). Each node can then cause its write barrier to track written objects for any of the regions being collected by any node.

Each node can then perform copying in the normal way. If a mutator writes to an object being copied by a different node, when it is determining the objects to re-copy, it will send information about any written remote object to the home node of the region in which the object is stored (the home node may forward it to a node collecting it) or directly to the node currently copying it, together with the new value of the written memory location. In response to reception of such information indicating that an object in the set of objects being copied has been written into, the object will be re-copied.

After a node has determined the destination address of each object to be copied (i.e., constructed the copy locator (117)), it sends a copy of its copy locator to all other nodes (alternatively, it might, e.g., send only information for those objects known to have external references, and rely on other nodes separately requesting information for any referring pointers that are detected only during the finalization stage).

It may be advantageous to wait for all nodes to report remote written objects before starting each re-copy. Each node will re-copy those objects that it is collecting that have been written into by any node.

As each node reaches (210), it sends a notification about being ready to stop mutators to other nodes (without yet stopping all of its mutators). When all nodes have reached that point (detected by having received the notification from all other nodes), each node stops its mutators, reads their write barrier buffers, and sends information to other nodes about any written objects that still need re-copying. Even if there are no objects to re-copy on a node, a notification to indicating there are no objects to re-copy (detected by the sending node) is sent to that node.

As each node updates references in (212), it will update references for both objects copied by itself and for objects copied by any other node. If other nodes did not send complete copies of their copy locators, then requests may be sent in this stage to the respective other nodes for any pointers to the regions being copied by them for the new locations of the referenced objects (such new references appearing during the collection cycle should be fairly rare). They then wait for responses to such requests before completing referring pointer update.

As each node receives notifications about objects to re-copy, it will re-copy those objects in the notification that have not already been re-copied during the finalization stage (the copying may take place any time before executing (213)). As the thread reaches (213), it will wait until it has received the notification about objects to re-copy from all other nodes, and has performed the indicated re-copying, and only then resumes from (213), which completes the collection cycle.

When properly implemented, the illustrated distributed garbage collection scheme should be able to handle arbitrarily large object graphs. Even though each node will start a stop-the-world pause at the same time in the above description, that pause is very short (even if locations of new copies are requested from a remote node, such requests may be replied to in microseconds at today's interconnect speeds and latencies). The overall stop-the-world pause would probably only last some milliseconds.

Detection of garbage cycles spanning multiple regions (and possibly multiple nodes) may be performed in any of a number of ways. The distributed garbage collection literature abounds with descriptions of various distributed tracing algorithms, and the snapshot-at-the-beginning tracing algorithm described above could be extended to implement distributed tracing. A person skilled in the art of distributed garbage collection should be able to implement such extension. See S. Abdullahi et al: Collection Schemes for Distributed Garbage, IWMM'92, pp. 43-81, LNCS 637, Springer-Verlag, 1992, which is hereby incorporated herein by reference, and references therein.

An alternative approach would be to perform local SATB tracing at each node to determine which pointers going out from the node are reachable from which entries to the node, effectively compressing or summarizing the local object graph into an in-out mapping. The compressed mappings could then be sent to one of the nodes for performing global transitive closure computation, or a distributed transitive closure computation could be used. For more information, see L. Veiga and P. Ferreira: Asynchronous, Complete Distributed Garbage Collection, Technical report RT/11/2004, INESC-ID/IST, Lisboa, Portugal, 2004 (updated 2005), which is hereby incorporated herein by reference.

### Miscellaneous

The term copying garbage collector includes garbage collectors that move objects to new memory areas, compacting garbage collectors (e.g., those using mark-and-sweep or reference counting with compaction), distributed garbage collectors that support object migration, and garbage collectors for persistent systems that copy objects to/from non-volatile storage.

While the invention has been described primarily in the context of a (region-based) copying collector, it would also be possible to use it in a (primarily) mark-and-sweep or a reference counting collector with compaction. In such collectors, the invention would likely be beneficial especially if they sometimes compact (i.e., copy/move) objects, migrate them to another node in a distributed system, replicate them to more than one node in a distributed system, or implement persistence by maintaining one or more copies of at least some of the objects on disk or other non-volatile storage. In such collectors, the mark-and-sweep or reference counting aspect could be part of the liveness analyzer (and especially with reference counting, also part of mutator execution), and objects could be freed in the sweep phase (e.g., by putting them on a freelist or marking them in a free bitmap) or as their count reaches zero during mutator execution. The literature, including some of the references incorporated herein, contains detailed descriptions of mark-and-sweep and reference counting methods.

While the description discusses copying as if it was between two memory locations in the main memory (102), either the source or the destination location or both could reside in some other type of memory, such as non-shared remote memory on a different node in a distributed system (typically accessible through the network (104)), non-volatile storage on a non-volatile storage device (typically part of the I/O subsystem (103)), or some other kind of memory. The memory could also be part of a distributed shared memory implementation. Mutators and/or the garbage collector could also utilize transactional memory.

Many variations of the above described embodiments beyond those mentioned above will be available to one skilled in the art. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented, e.g., as state machine states, logic circuits, or optics in hardware components, as instructions, subprograms, or processes executed by a processor, or a combination of these and other techniques.

It is to be understood that the aspects and embodiments of the invention described in this specification may be used in any combination with each other. Several of the aspects and embodiments may be combined together to form a further embodiment of the invention, and not all features, elements, or characteristics of an embodiment necessarily appear in other embodiments. A method, an apparatus, or a computer program product which is an aspect of the invention may comprise any number of the embodiments or elements of the invention described in this specification. Separate references to “an embodiment” or “one embodiment” refer to particular embodiments or classes of embodiments (possibly different embodiments in each case), not necessarily all possible embodiments of the invention. The subject matter described herein is provided by way of illustration only and should not be construed as limiting. Captions are only intended to help the reader and should not be interpreted as limiting.

Stop-the-world synchronization (node-local or cluster-wide in a distributed system) could be used instead of soft synchronization for some or all synchronizations without sacrificing correctness but such approach would usually incur additional overhead.

A pointer should be interpreted to mean any reference to an object, such as a memory address, an index into an array of objects, a key into a (possibly weak) hash table containing objects (or addresses of objects), a global unique identifier, or some other object identifier that can be used to retrieve and/or gain access to the referenced object. In some embodiments pointers may also refer to fields of a larger object.

In this specification, copying was described as being within the local memory of a computer. However, in a distributed system, copying may be to a another node in the distributed system. In such embodiments, the copying may be implemented using messages over an interconnection network (part of the network (104)). Another aspect of copying in such environments is receiving the copy at the other node, and storing it in memory at the desired address. In such systems, memory allocation from regions residing at the remote node may involve sending allocation requests to the other node. Copying as described herein may therefore be used for implementing object migration from one node to another.

In this specification, selecting has its ordinary meaning, with the extension that selecting from just one alternative means taking that alternative (i.e., the only possible choice), and selecting from no alternatives either returns a “no selection” indicator (such as a NULL pointer), triggers an error (e.g., a “throw” in Lisp or “exception” in Java), or returns a default value, as is appropriate in each embodiment.

Computer-readable media can include, e.g., computer-readable magnetic data storage media (e.g., floppies, disk drives, tapes), computer-readable optical data storage media (e.g., disks, tapes, holograms, crystals, strips), semiconductor memories (such as flash memory and various ROM technologies), media accessible through an I/O interface in a computer, media accessible through a network interface in a computer, networked file servers from which at least some of the content can be accessed by another computer, data buffered, cached, or in transit through a computer network, or any other media that can be accessed by a computer.

What is claimed is:

1. In a computing system, a method of copying a set of objects, comprising:
allocating space for a new copy of an original object that is a member of the set of objects;
copying the original object to the space allocated for the new copy;
during the copying, tracking writes to the original object by mutators; and
re-copying the original object to the allocated space if the original object has been written into during copying.

2. The method of claim 1, wherein the copying and re-copying take place during a garbage collection cycle and at least one mutator is executing concurrently with the copying.

3. The method of claim 2, further comprising updating all references to objects in the set of objects to refer to the corresponding new copies atomically with respect to mutators.

4. The method of claim 3, wherein a final re-copy is done atomically with the updating of the references with respect to mutators.

5. The method of claim 1, wherein space is allocated for new copies of a plurality of objects that are members of the set before copying the first one of the objects.

6. The method of claim 1, wherein the space is allocated from a popular object region.

7. The method of claim 1, wherein, in a distributed system, the space is allocated from a node different from the home node of the original object.

8. The method of claim 1, further comprising:
during the re-copying, tracking writes to the original object by mutators; and
re-copying the original object a second time to the allocated space if the original object has been written into during the first re-copying.

9. The method of claim 1, wherein mutators access the original object but not the new copy during copying and re-copying.

10. The method of claim 9, wherein after a mutator has accessed the new copy, it will no longer access the original object.

11. The method of claim 9, wherein writes by mutators to a new copy after the last re-copy, but before all mutators have switched to using only new copies, are propagated to the corresponding original object.

12. The method of claim 9, wherein, after the last re-copy but before all mutators have ceased accessing any objects in the set, if a write to a new copy is performed by a thread holding a mutex, propagating the write to the original copy before another thread obtains a lock on the mutex.

13. The method of claim 1, wherein the re-copying copies the original object to the allocated space in its entirety.

14. The method of claim 1, wherein the re-copying copies only the modified fields of the original object to the new copy.

15. The method of claim 14, wherein the re-copying is implemented by a write barrier that propagates a write to the original object also to the corresponding field in the new copy.

16. The method of claim 1, wherein copying updates any pointers in the new copy pointing to any of the objects in the set to point to their respective new copies.

17. The method of claim 1, wherein re-copying updates any pointers in re-copied fields in the new copy pointing to any of the objects in the set to point to their respective new copies.

18. The method of claim 1, further comprising:
receiving information from another node in a distributed system indicating that an object in the set has been written into by a mutator during copying; and
re-copying the object in response to receiving such information.

19. The method of claim 1, further comprising:
tracking writes by mutators to an object being copied by another node in a distributed system; and
in response to detecting a write to the object, sending information to that other node indicating that the object has been written into.

20. The method of claim 1, wherein tracking writes comprises:
using a write barrier to record writes in a thread-local write barrier buffer; and
using a soft synchronization to read the thread-local write barrier buffer.

21. A computer program product stored on a tangible computer readable medium operable to cause a computer to:
allocate space for a new copy of an original object that is a member of a set of objects to be copied;
copy the original object to the space allocated for the new copy;
track writes to the original object by mutators during the copying; and
re-copy the original object to the allocated space if the original object has been written into during copying.

22. The computer program product of claim 21, further operable to cause the computer to perform the allocating, copying, tracking, and re-copying during a garbage collection cycle and concurrently execute mutators.

23. The computer program product of claim 21, further operable to cause the computer to:
receive information from another node in a distributed system indicating that an object in the set has been written into by a mutator during copying; and
re-copy the object in response to receiving such information.

24. The computer program product of claim 21, further operable to cause the computer to:
track writes by mutators to an object being copied by another node in a distributed system; and
in response to detecting a write to the object, send information to that other node indicating that the object has been written into.

25. A computing system comprising:
a means for allocating space for a new copy of an original object that is a member of a set of objects to be copied;
a means for copying the original object to the space allocated for the new copy;
a means for tracking writes to the original object during the copying; and
a means for re-copying the original object to the allocated space if the original object has been written into during copying.

26. The computing system of claim 25, further comprising a means for collecting garbage, where the means for copying is configured to be active only while the means for collecting garbage is active.

27. The computing system of claim 26, further comprising a means for updating references to objects in the set of objects to be copied to refer to the respective new copies atomically with respect to mutators.

28. The computing system of claim 25, wherein the means for tracking writes uses a thread-local write barrier buffer for recording the writes.

29. The computing system of claim 28, further comprising a means for reading tracked writes using soft synchronization.

30. A computing system comprising:
an allocator configured to allocate space for a new copy of an original object that is a member of a set of original objects to be copied;
a copier connected the allocator and a memory for copying the original object to the space allocated for the new copy;
a write tracker connected to one or more mutators, configured to track writes to at least one of the original objects during copying; and
a re-copier connected to the write tracker and the memory, configured to re-copy at least one of the original objects to the space allocated for its new copy in response to the write tracker detecting at least one write to it.
